(19) United States
(12) Patent Application Publication
(10) Pub. No.: US 2002/0060147 A1
(43) Pub. Date: May 23, 2002

(54) Apparatus for distilling water using solar energy and method for use thereof

(76) Inventor: David M. Ludwig, Tucson, AZ (US)

Correspondence Address: BIRDWELL, JANKE & DURANDO, PLC, Suite 1925, 900 SW Fifth Avenue, Portland, OR, 97204, US

(21) Appl. No.: 10/021,337

(22) Filed: Dec. 12, 2001

Related U.S. Application Data
(63) Continuation-in-part of application No. 09/589,138, filed on Jun. 7, 2000.
(60) Provisional application No. 60/174,341, filed on Jan. 4, 2000.

(51) Int. Cl. B01D 3/02; C02F 1/14

(52) U.S. Cl. 203/10; 47/17; 159/903; 202/234; 203/100; 203/DIG. 17

(57) ABSTRACT

A method and apparatus for distilling water using solar energy. A distilling apparatus employs anthracite coal as the heat absorbing medium. The materials used in the apparatus are restricted substantially to glass, coal, silicone and a noble metal such as stainless steel to increase longevity and water quality. To produce and maintain optimum health, water treated according to the invention should make up the bulk of a person's daily water intake, exclusive of the water that is contained in foods and beverages, and the water should be ingested within 7 days of the time it was evaporated.

This is a continuation-in-part of U.S. Ser. No. 09/589,138, filed Jun. 7, 2000, now pending.

### BACKGROUND OF THE INVENTION

This application claims the benefit of provisional application Serial No. 60/174,341, filed Jan. 4, 2000.

The present invention relates to an apparatus for distilling water using solar energy and method for use thereof, particularly to provide hot or cold water for irrigation and drinking.

The need for treating water to make it safe and satisfying for human needs, particularly for drinking, is easily appreciated. It is common experience that tap water in many areas of the country where water is not plentiful may contain high concentrations of contaminants that make the water taste bad as well as, potentially, pose health risks. It is also increasingly appreciated that people should drink a substantial amount of pure water, and this is one of the reasons for the popularity of bottled water, which people enjoy but which has the obvious disadvantage that it is expensive. Bottled water has also been found to be inconsistent in quality.

The interest in employing solar energy where practical as an alternative energy source is also well known. Distilling water, i.e., evaporating the water and collecting the water as condensate, is a process that is particularly well suited to being driven by solar energy.

There are many known apparatus for distilling water using solar energy. These frequently include a black body absorber, to absorb a wide frequency spectrum of the sun's electromagnetic radiation to provide for maximum heating, a glass or plastic covered enclosure to provide for a “greenhouse” effect to trap the heat, and, often, a reflector or concentrator to concentrate the sun's rays on the water to be distilled, such as a parabolic mirror or fresnel lens.

There are some important problems with these known apparatus. A reflector or concentrator adds significant cost and complexity, and becomes less useful over time as condensation forms on the reflector or concentrator, inevitably bringing with it some contamination from the atmosphere into or onto the apparatus. This contamination decreases the reflectivity or transmissivity of the reflector or concentrator.

The efficiency of the black body used for the absorber is also diminished over time as sediment and other contaminants in the water are left behind in distillation to collect thereon. The glass or plastic cover itself collects dust and contamination which blocks some of the energy from the water to be distilled. Moreover, such apparatus are often provided so that the cover is relatively airtight, to shield the interior of the apparatus from contaminants in the atmosphere. However, the lack of ventilation may hasten the growth of bacteria, fungus and algae in the apparatus, which detracts from the capability of the apparatus to heat the water and to provide the water in a condition that is safe and pleasant to drink. Further, volatile gases in the water are not permitted to escape the apparatus when it is relatively airtight.

Making the requirements for an optimally effective water distilling apparatus even more stringent, the materials of which the apparatus is formed may introduce contaminants themselves, such as by outgassing, or by corrosion or degradation as a result of contact with the water or exposure to radiation from the sun and elements and charged particles in the atmosphere.

Accordingly, there is a need for an apparatus for distilling water using solar energy and method for use thereof that provides for an increased energy efficiency, that can be maintained to a greater degree over time, that provides for simplicity of construction and a consequent reduction in manufacturing costs, and that provides optimally healthful drinking water.

### SUMMARY OF THE INVENTION

The apparatus for distilling water using solar energy and method for use thereof of the present invention solves the aforementioned problems and meets the aforementioned needs by providing a water holding volume including a black body absorber of fragmented anthracite coal over which water to be distilled is controllably flowed and allowed to settle, and a greenhouse covering disposed above the black body absorber which preferably includes at least one pitched roof element formed of glass, having preferably, a pitch of at least 30 degrees. A gutter is disposed at the base of the pitched roof element to collect and carry water that has condensed on the pitched roof element and which flows down the pitched roof element under the force of gravity. Preferably, all of the components of the apparatus are selected and connected together to prevent leeching or out-gassing of contaminants, or corrosion by the water, by restricting the materials in the apparatus that come into contact with the water to glass, noble metal, coal and silicone.

Preferably, ventilation means are provided to dry the interior volume of the apparatus during times that the sun is not actively evaporating water, to discourage the formation of algae and other organisms.

A method is also provided for maintaining and producing optimum health that results from the recognition that water treated according to the invention remains more healthful than ordinary water for a period of 7 days after it has been evaporated. The method comprises ingesting solar evaporated water daily so as to ensure that the water is not “older” than this period, in amounts that are substantial by comparison to the total water ingested exclusive of the water present in food that has also been ingested.

Therefore, it is a principal object of the present invention to provide a novel and improved apparatus for distilling water using solar energy and method for use thereof.

It is another object of the present invention to provide an apparatus for distilling water using solar energy and method for use thereof that provides for increased energy and distillation efficiency.

It is yet another object of the present invention to provide an apparatus for distilling water using solar energy and method for use thereof that provides for maintaining energy and distillation efficiency over the life of the apparatus.

It is still another object of the present invention to provide an apparatus for distilling water using solar energy and method for use thereof that provides for increasing the longevity of the distilling apparatus.

It is a further object of the present invention to provide an apparatus for distilling water using solar energy and method for use thereof that provides for simpler components and, therefore, decreased manufacturing costs.

It is still a further object of the present invention to provide an apparatus for distilling water using solar energy and method for use thereof that discourages the growth of organisms in the apparatus.

It is yet a further object of the present invention to provide an apparatus for distilling water using solar energy and method for use thereof that provides for storing the water for use while discouraging the growth of organisms in the water.

It is still another object of the present invention to provide an apparatus for distilling water using solar energy and method for use thereof that provides for producing and maintaining optimum health.

The foregoing and other objects, features and advantages of the present invention will be more readily understood upon consideration of the following detailed description of the invention, taken in conjunction with the following drawings.

### BRIEF DESCRIPTION OF THE DRAWINGS

FIG. 1 is a pictorial view of an apparatus for distilling water using solar energy according to the present invention.

FIG. 2 is a pictorial view of a vent according to the present invention for use in the apparatus of FIG. 1 taken along the line 2-2.

FIG. 3 is a partial section of the apparatus of FIG. 1, as shown in FIG. 2.

FIG. 4 is a pictorial view of a “coal pouring” method and structure according to the present invention.

FIG. 5 is a pictorial view of a vent according to the present invention.

FIG. 6 is a pictorial view of the apparatus of FIG. 1 shown installed in a yard for irrigation, and showing a receptacle according to the present invention for storing the water distilled in the apparatus.

FIG. 7 is a more detailed pictorial view of the receptacle of FIG. 6.

FIG. 8 is a plan view of the apparatus of FIG. 1 modified for use over an aqueduct according to the present invention.

### DETAILED DESCRIPTION OF A PREFERRED EMBODIMENT

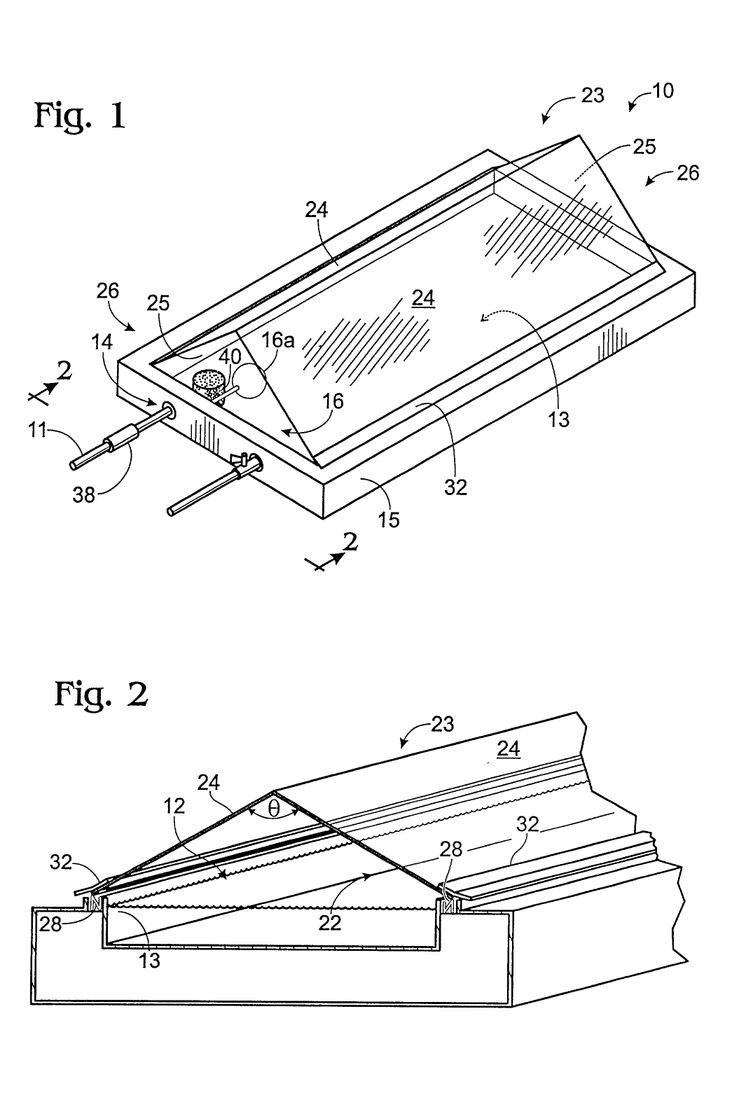

Referring to FIGS. 1 and 2, a preferred apparatus 10 for distilling water using solar energy according to the present invention is shown. The apparatus 10 includes a water holding volume 12 that is formed of stainless steel in the form of a tray 13. The volume is for receiving water to be distilled, which is provided through an inlet connection 14 communicating with a city water line 11 or the like, and metered by a float valve 16 and float 16a which admits water into the tray whenever the level of the water drops below a predetermined amount. The float valve and the inlet connection 14, which are typically formed of a metal that differs from the metal used for the tray 13, are preferably electrically isolated from the tray, to prevent galvanic corrosion. This is accomplished with, for example, plastic or fiber washers. The tray is preferably set into a foam insulated shell 15 that is preferably protected by a galvanized sheet steel exterior. The insulation maintains heat in the tray 13 so that it may continue to transfer heat to the water for evaporating the water after the sun has set.

Referring to FIG. 3, the tray contains a black, solar energy absorbing material 18 as well as incoming water. It has been determined that the most effective material for this purpose in a solar distiller is coal (as used herein, “coal” includes charcoal), preferably anthracite coal. The coal is provided in fragmented form, preferably in granules that are not larger than about one-half the size of a pea. One of the advantages the coal has been determined to provide in this application is an additional amount of filtration and extraction of dissolved gases. Another advantage is that it has a surface that naturally sloughs off sediments and deposits left by the evaporating water. These sediments and deposits tend to adhere to or remain on the surfaces of the typical black body absorber employed in the prior art, increasing its reflectivity and thereby degrading its ability to absorb solar energy. On the other hand, the same sediments and deposits have been observed to fall off the surfaces of coal granules, into the cracks and openings therebetween, which has further been observed to greatly increase the service life and efficiency of the apparatus. To further these characteristics even more, it has been found that periodically stirring the fragments is effective to increase the settling of the sediments and deposits.

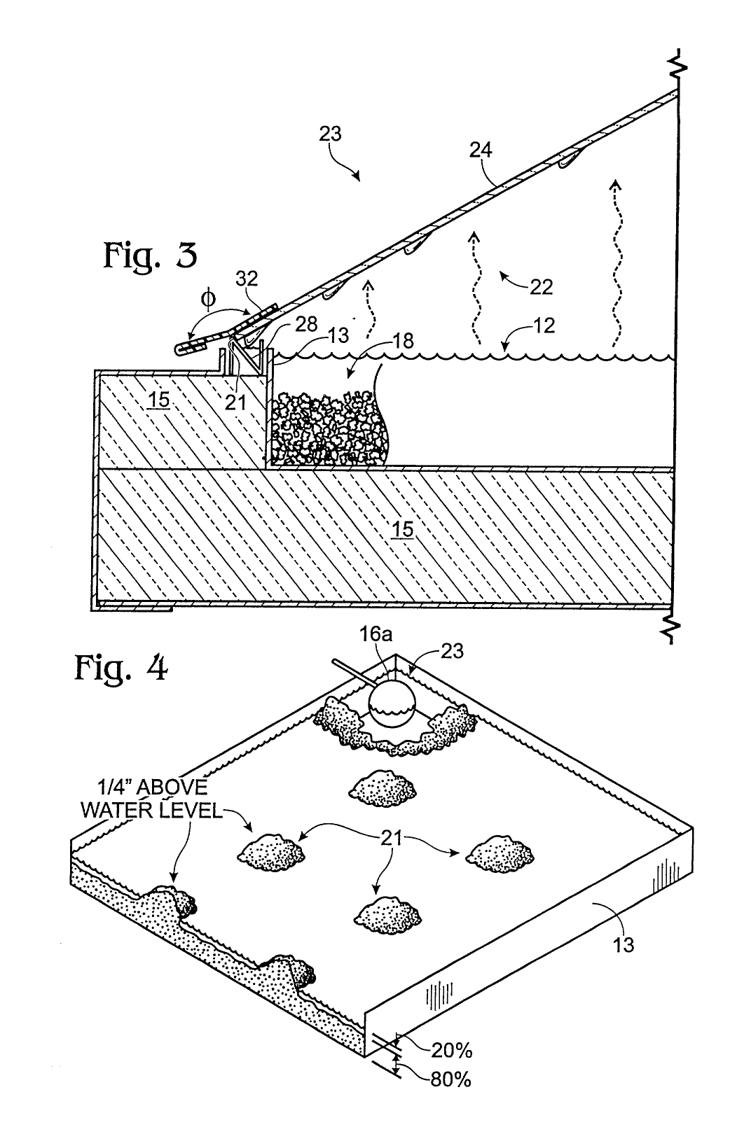

Turning to FIG. 4, preferably, the fragments or granules are provided to a depth, in relation to the depth of water in the tray 13, that is approximately 80% of the depth of the water. In addition, some hillocks 21 are preferably provided that extend about ¼″ above the water, and the coal is built up around the float 16a of the float valve 16. This “coal pouring” configuration is believed to provide for an optimum yield of distilled water.

Returning to FIGS. 1-3, it is recognized that a black body absorber is also an efficient radiator of the energy that is absorbed, and this is used to advantage by providing a greenhouse covering 22 disposed above the water holding volume that blocks infrared radiation, which is felt as heat, but that admits radiation of higher frequencies. Glass is the preferred material even though plastic can be used as a greenhouse covering. More particularly, for ease of construction, low cost and simplicity the preferred greenhouse covering is a tent-like structure 23 formed of two panes of glass 24, though three or more panes arranged in a “zig-zag” configuration would also be a reasonably inexpensive and simple alternative. The structure 23 is placed over the tray to form a substantially enclosed volume which retains the heat radiated by the black body absorber 18. This volume receives water evaporating from the water holding volume 12, the evaporated water condensing on interior surfaces of the covering 22 as distilled water.

The structure 23 provides for a minimum slope or pitch. It has been determined that the pitch, measured with respect to the horizon, of the panes should be at least about 30 degrees to prevent the accumulation of debris and contamination on the exterior surfaces thereof. Such a minimum pitch provides for the advantage that the external atmosphere does not reduce the transmissivity of solar energy into the heat absorbing volume appreciably over time. An included angle θ (FIG. 2) of no more than about 120 degrees between two planes of glass 24 provides the desired pitch when the apparatus is fixed properly with respect to the horizontal.

The panes of glass are preferably joined to one another with a silicone adhesive material. Two substantially triangular panes 25 of glass are also joined to the structure at each end 26. These may be disposed vertically.

Referring particularly to FIGS. 2 and 3, gutters 28 are provided to collect condensate from the structure 23. The gutters are formed of stainless steel, most simply by bending sheet material. The gutters are disposed so that they abut an edge of the structure 23, just above the tray 13, as best seen in FIG. 3. Preferably a gutter is provided adjacent each pane of glass 24 and 25 and are joined at their ends to form a continuous trough encircling the interior of the structure 23. Water condensing on the interior surfaces of the structure 23 will run down along these surfaces into the gutters for collection. The gutters are slightly sloped to carry the water to one of the ends 26 of the structure, where it can be picked up and carried to a destination for storage or immediate use. Preferably, the gutters are spaced from the tray to break the heat conductive path that would otherwise be present between the glass and the tray. In cooperation with the insulation 15, this enhances the capability of the apparatus 10 to continue to transfer heat from the tray to the water for evaporating the water after the sun has set.

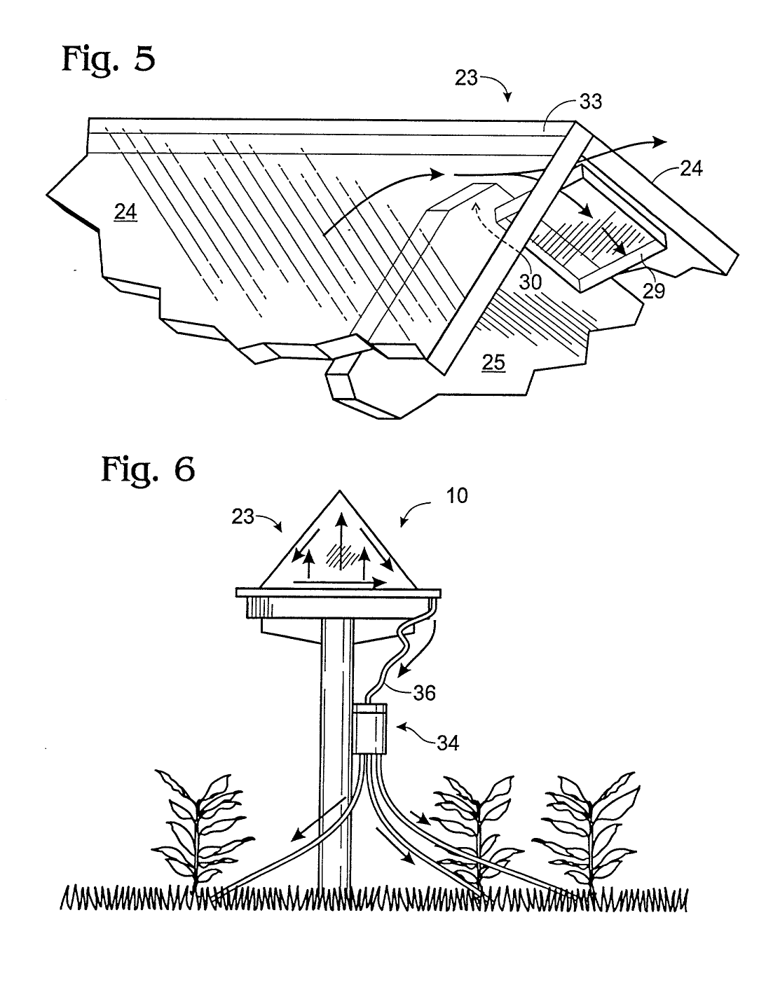

The invention advantageously provides for exhausting the apparatus 10. Referring to FIG. 5, a vent 30 is preferably provided at the top of the structure 23, e.g., by removing the apex of one or both of the triangular panes 25 and adding an additional glass shield 29 abutting one of the panes 24 and the triangular pane 25 to shield the vent and guide the airflow as shown by the arrows. Turning back to FIG. 3, in addition, no sealing is necessary along the junction between the panes 24 and the gutters 28, and bottom corners 27 of the structure 23 are left unsealed as well. Leaving these junctions substantially or fully unsealed has been found to be effective at permitting outside air to enter through the junction, into the heat absorbing volume 22, displacing air inside the volume out the vent 30. However, other venting means may also be provided once it is recognized that adequate ventilation materially enhances the operating life of the apparatus by drying the gutters during periods, such as the night-time, when evaporation in the apparatus is not occurring to any substantial degree. This discourages the formation of algae and bacteria in the gutters as well as throughout the interior of the apparatus 10.

Where all or parts of the junction between the structure 23 and the gutters 28 are left unsealed, dust shields 32 are advantageously placed on the exterior of the structure, over this junction, in order to help deflect externally applied water and dust from the structure. As best seen in FIG. 3, two opposite sides 41 of the dust shield 32 that face outwardly, away from the tray 13, form an included angle φ that is less than 180 degrees. A dust shield 33 is preferably also provided over the vent 30, this dust shield being formed of glass, due to its location, so as not to block incoming solar radiation.

Turning to FIG. 6, the water collected by the gutters is preferably captured and stored for use in a glass receptacle 34 that has been tinted, e.g., bronzed, to reduce the amount of visible light that may enter the receptacle yet provide for sufficient transparency to view the water level. Protecting the water in the container from visible light discourages the growth of microorganisms and algae and is believed to be important even where the container is maintained indoors. The water is preferably carried from the apparatus 10 to the container 34 in a polyethylene tube 36. The receptacle 34 preferably includes a dust shielded vent (not shown) serving the same purpose served by the vent 30.

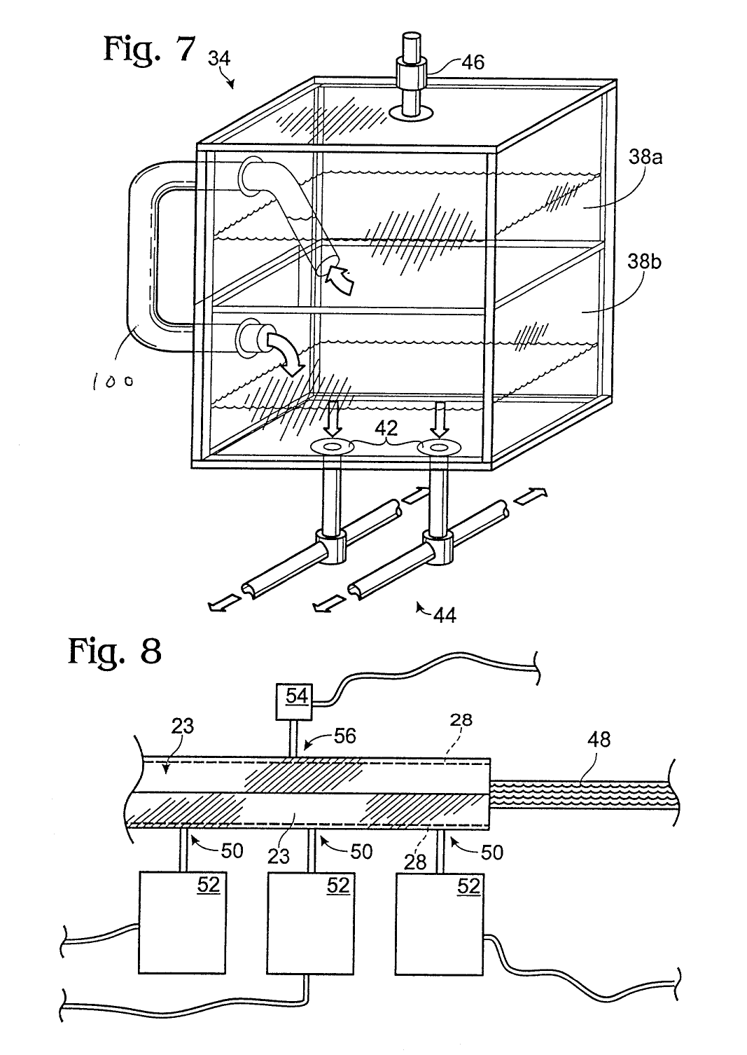

FIG. 6 shows use of the apparatus 10 for irrigation. Turning to FIG. 7, the receptacle 34 is preferably formed into upper and lower chambers 38a and 38b for this purpose. The upper chamber 38a receives the water from the apparatus 10 and fills the chamber. The upper chamber is preferably emptied into the lower chamber regularly, which may be arranged by providing a siphon 100 or a pump. Outlets 42 in the lower chamber provide for drip irrigation which is distributed to plants through a distribution system 44.

For irrigation purposes, the receptacle 34 is advantageously placed outside, with the apparatus 10, such as shown in FIG. 6. It has been found that plants in the Southwest portion of the United States, i.e., a relatively arid environment, with water provided directly from the apparatus 10 as shown, grow substantially faster with such water than they do with water provided from other sources, such as tap water. For drinking use, the receptacle 34 is preferably kept indoors.

The method of the invention preferably provides additional filtration steps. Turning back to FIG. 1, the water that is provided to the apparatus is preferably passed through a filter 38 that is upstream of the float valve 16, another filter 40 that is downstream of and proximate the float valve. Referring to FIG. 7, the glass receptacle 34 preferably includes yet another filter 46 similar to the filter 38 in line with the glass receptacle 34. All of these filters preferably employ charcoal as the filtering medium, and the filter 40 may be constructed in the form of a stainless steel can with holes at the bottom. The function of the charcoal is primarily to remove gases and bulk contaminants from the water, not minerals or organic material. Hence, the filtration steps are provided to enhance the distillation process and will not substitute for it.

There are many people, including some physicians, who believe that water becomes “clustered” or “structured” as a result of exposure to various forms of energy, including light energy, and that ingesting water having this property can have a beneficial effect on health. For example, as reported by Norman deLauder Mikesell in a 1985 article currently being published on the Internet and entitled STRUCTURED WATER: ITS HEALING EFFECTS ON THE DISEASED STATE, healthful and therapeutic effects of structured water include stopping the growth of pathogenic bacteria and cancer tumors, and by enhancing organ functions and endocrine excretions.

In view of this, the present inventor has recognized that structured water should be being produced in a solar distiller due to exposure to solar radiation. Pursuing this idea, the inventor has tested water from the solar distiller apparatus 10 for its spectral absorption characteristics and determined that these characteristics are different for water from the apparatus 10 than for ordinary tap water, but that this difference was found to diminish to zero over a time of about one week. It is believed that the difference in spectral absorption characteristics is due to structuring of the water, so that solar distilled water may be used to produce and maintain optimum health where a substantial amount of the water is ingested per day, ensuring that the water ingested is not more than about 7-10 days old measured from the time that it was evaporated in the distiller. A “substantial amount” of solar distilled water for a person means at least about 80% of the total water ingested by the person, excluding water that is in food. “Daily” means at least 90% of the days in any given month.

To ensure that the structured water provided for irrigation or for drinking does not age beyond the time at which it loses a substantial amount of its structure, the temporal regularity with which water received by the receptacle 34 is let out of the receptacle may be appropriately adjusted. For example, the height of the end of the siphon with respect to the floor of the receptacle 38a may be adjusted, and the size and shape of the upper chamber 38a may also be adjusted. Other means for regulating the storage time for water in the receptacle 34 will be immediately apparent to those having ordinary mechanical skill.

The inventor has also recognized that the benefits of structured water can be exploited by covering aqueducts with glass panels and continuously capturing the distillant.

Referring to FIG. 8, more particularly, it is one aspect of the invention to provide a large scale version of the structure 23 and gutters 28 to place over an otherwise open aqueduct 48. A black body absorber could also be provided in the bed of the aqueduct; however, this is not necessary to obtain many of the advantages described herein. The water collected from the gutters 28 may be removed at selected locations 50 along the aqueduct and stored in containers or pools 52 for distribution, or the water may be pumped (e.g., at 54) from selected locations 56 to remote locations for storage or use.

As mentioned above, the materials used in the apparatus to which the evaporating and evaporated water is exposed should be limited according to the invention. The light transmissive material used in the apparatus is glass. Metal parts of the apparatus interior thereto are non-corroding, and should be at least as noble, as defined by the galvanic series, as stainless steel. Where a sealant or adhesive is required, it should be silicone, preferably aquarium grade or pure silicone. It is preferable that no less than about 98% of the surface area inside the heat absorbing volume 22 should be of these materials in order that the apparatus may provide water that is perceptibly free of solid and gaseous contamination for a maximum length of time.

It is to be recognized that, while a particular method and apparatus for distilling water using solar energy has been shown and described as preferred, other configurations could be utilized, in addition to configurations already mentioned, without departing from the principles of the invention.

The terms and expressions which have been employed in the foregoing specification are used therein as terms of description and not of limitation, and there is no intention of the use of such terms and expressions of excluding equivalents of the features shown and described or portions thereof, it being recognized that the scope of the invention is defined and limited only by the claims which follow.

1. A method for producing and maintaining optimum health, comprising the steps of evaporating water by exposing the water to radiation emanating from the sun, collecting the evaporated water, ingesting a substantial amount of the collected water daily such that not more than 7 days passes from the time the water has been evaporated to the time that it is ingested.

2. The method of claim 1, wherein said ingesting is by an animal.

3. The method of claim 1, wherein said ingesting is by a plant.

4. A method for utilizing an aqueduct, comprising covering the aqueduct with a greenhouse covering including at least two substantially planar, substantially glass coverings, wherein said coverings form an included angle therebetween of at most about 120 degrees.

5. The method of claim 4, further comprising collecting condensate from interior surfaces of said coverings and maintaining said condensate separate from the water in the aqueduct thereafter.

6. The method of claim 4, including providing said condensate to a drinking water supply within 7 days of the time the water was evaporated.
